(19) United States
(12) Patent Application Publication
(10) Pub. No.: US 2026/0339792 A1
(43) Pub. Date: Oct. 29, 2026

(54) METHOD, DEVICE AND PROGRAM PRODUCT FOR RESTORING DATA

(71) Applicant: Dell Products L.P., Round Rock, TX (US)

(72) Inventors: Qiaosheng Zhou, Beijing (CN); Huan Chen, Beijing (CN); Chen Gong, Beijing (CN); Jian Liu, Beijing (CN); Changxu Jiang, Chengdu (CN)

(21) Appl. No.: 19/538,538

(22) Filed: Feb. 12, 2026

(30) Foreign Application Priority Data
Apr. 25, 2025 (CN) 202510530323.X

(51) Int. Cl. G06F 11/1446

(52) U.S. Cl. CPC G06F 11/1469

(57) ABSTRACT

Techniques for restoring data involve determining a damaged target node in a target snapshot group, wherein the target snapshot group includes a plurality of data path trees, each of the plurality of data path trees including a leaf node, an intermediate node, and a top node. Such techniques further involve, in response to the damaged target node including a damaged leaf node, reconnecting the leaf node to the intermediate node of the target snapshot group by restoring the damaged leaf node using a snapshot node of the damaged leaf node in the target snapshot group. Such techniques further involve, in response to the damaged target node including a damaged intermediate node, reconnecting the intermediate node to the top node of the target snapshot group by restoring the damaged intermediate node using a snapshot node of the damaged intermediate node in the target snapshot group.

### CROSS-REFERENCE TO RELATED APPLICATION

This application claims priority to Chinese Patent Application No. CN202510530323.X, on file at the China National Intellectual Property Administration (CNIPA), having a filing date of Apr. 25, 2025, and having “METHOD, DEVICE AND PROGRAM PRODUCT FOR RESTORING DATA” as a title, the contents and teachings of which are herein incorporated by reference in their entirety.

### TECHNICAL FIELD

The present disclosure relates to the field of data storage, and more particularly to a method, a device, and a computer program product for restoring data.

In the current digital era, data is the core asset for the operations and development of various entities. For enterprises, their daily operations are highly dependent on massive data stored in servers, encompassing critical information such as financial details and customer profiles. Once such data is lost due to unexpected circumstances, it is very likely to cause interruption of business processes, resulting in damage to economic interests and even legal disputes. For individuals, the loss of data such as precious family photos, important work documents, and closely connected contact information stored in devices will bring immeasurable losses.

The data restoration technology, as a continuously evolving technology, is committed to restoring data that has been lost or damaged due to various reasons to a usable state through diverse and complex technical means. In some cases, data restoration can be implemented by restoring data path trees that reflect data storage addresses, i,e., restoring the address mapping of data. When storage location information of data is damaged, it is necessary to reconstruct these address mapping relationships to correctly map a logical address with a physical address of the data, thereby enabling effective data restoration.

### SUMMARY OF THE INVENTION

Embodiments of the present disclosure provide a method, a device, and a computer program product for restoring data.

In a first aspect of the embodiments of the present disclosure, a method for restoring data is provided. The method includes determining a damaged target node in a target snapshot group, wherein the target snapshot group includes a plurality of data path trees, each of the plurality of data path trees including a leaf node, an intermediate node, and a top node. The method further includes, in response to the damaged target node including a damaged leaf node, reconnecting the leaf node to the intermediate node of the target snapshot group by restoring the damaged leaf node using a snapshot node of the damaged leaf node in the target snapshot group. The method further includes, in response to the damaged target node including a damaged intermediate node, reconnecting the intermediate node to the top node of the target snapshot group by restoring the damaged intermediate node using a snapshot node of the damaged intermediate node in the target snapshot group.

In a second aspect of the embodiments of the present disclosure, an electronic device is provided. The electronic device includes one or more processors; and a storage apparatus configured to store one or more programs that, when executed by the one or more processors, cause the one or more processors to perform actions including determining a damaged target node in a target snapshot group, wherein the target snapshot group includes a plurality of data path trees, each of the plurality of data path trees including a leaf node, an intermediate node, and a top node. The actions further include, in response to the damaged target node including a damaged leaf node, reconnecting the leaf node to the intermediate node of the target snapshot group by restoring the damaged leaf node using a snapshot node of the damaged leaf node in the target snapshot group. The actions further include, in response to the damaged target node including a damaged intermediate node, reconnecting the intermediate node to the top node of the target snapshot group by restoring the damaged intermediate node using a snapshot node of the damaged intermediate node in the target snapshot group.

In a third aspect of the embodiments of the present disclosure, a computer program product is provided. The computer program product is tangibly stored on a non-volatile computer-readable medium and includes machine-executable instructions that, when executed, cause a machine to perform actions including determining a damaged target node in a target snapshot group, wherein the target snapshot group includes a plurality of data path trees, each of the plurality of data path trees including a leaf node, an intermediate node, and a top node. The actions further include, in response to the damaged target node including a damaged leaf node, reconnecting the leaf node to the intermediate node of the target snapshot group by restoring the damaged leaf node using a snapshot node of the damaged leaf node in the target snapshot group. The actions further include, in response to the damaged target node including a damaged intermediate node, reconnecting the intermediate node to the top node of the target snapshot group by restoring the damaged intermediate node using a snapshot node of the damaged intermediate node in the target snapshot group.

It should be understood that the content described in the Summary of the Invention part is neither intended to limit key or essential features of the embodiments of the present disclosure, nor intended to limit the scope of the present disclosure. Other features of the present disclosure will become readily understood from the following description.

### BRIEF DESCRIPTION OF THE DRAWINGS

The above-mentioned and other features, advantages, and aspects of the embodiments of the present disclosure will become more apparent with reference to the accompanying drawings and the following detailed description. In the accompanying drawings, identical or similar reference numerals represent identical or similar elements, in which

FIG. 1 illustrates a schematic diagram of an example environment in which embodiments according to the present disclosure can be implemented;

FIG. 2 illustrates a flow chart of a method for restoring data according to some embodiments of the present disclosure;

FIG. 3 illustrates a schematic diagram of a bidirectional reconnection according to an embodiment of the present disclosure;

FIG. 4 illustrates an effect diagram of a downward connection according to the present disclosure;

FIG. 5 illustrates a schematic diagram of processing island nodes according to an embodiment of the present disclosure;

FIG. 6 illustrates a schematic diagram of restoring a plurality of damaged leaf nodes according to an embodiment of the present disclosure; and

FIG. 7 illustrates a schematic block diagram of an example device that can be used to implement the embodiments of the present disclosure.

### DETAILED DESCRIPTION

The individual features of the various embodiments, examples, and implementations disclosed within this document can be combined in any desired manner that makes technological sense. Furthermore, the individual features are hereby combined in this manner to form all possible combinations, permutations and variants except to the extent that such combinations, permutations and/or variants have been explicitly excluded or are impractical. Support for such combinations, permutations and variants is considered to exist within this document.

It should be understood that the specialized circuitry that performs one or more of the various operations disclosed herein may be formed by one or more processors operating in accordance with specialized instructions persistently stored in memory. Such components may be arranged in a variety of ways such as tightly coupled with each other (e.g., where the components electronically communicate over a computer bus), distributed among different locations (e.g., where the components electronically communicate over a computer network), combinations thereof, and so on.

The embodiments of the present disclosure will be described in more detail below with reference to the accompanying drawings. Although some embodiments of the present disclosure are illustrated in the accompanying drawings, it should be understood that the present disclosure may be implemented in various forms and should not be construed as being limited to the embodiments set forth herein. Rather, these embodiments are provided for a more thorough and complete understanding of the present disclosure. It should be understood that the accompanying drawings and embodiments of the present disclosure are for illustrative purposes only, and are not intended to limit the scope of protection of the present disclosure.

In the description of embodiments of the present disclosure, the term “include” and similar terms thereof should be understood as open-ended inclusion, i.e., “including but not limited to.” The term “based on” should be understood as “based at least in part on.” The term “an embodiment” or “the embodiment” should be construed as “at least one embodiment.” The terms “first,” “second,” and the like may refer to different or the same objects. Other explicit and implicit definitions may also be included below.

In the related art, a data path tree is limited only to three levels, i.e., a leaf level, an intermediate level, and a top level. When data path trees are restored, for a specific control group, leaf nodes are reconnected to intermediate nodes first, followed by reconnection of the intermediate nodes and top nodes, after which damaged nodes are restored according to correspondence relationships between the data path trees in the control group. After the damaged nodes are restored, the leaf nodes are reconnected to the intermediate nodes, and the intermediate nodes are reconnected to the top nodes. This will bring many issues. For example, for a first leaf node of a first data path tree and a second leaf node of a second data path tree in a control group, if the first leaf node and the second leaf node correspond to the same data block, and path information of the first leaf node is lost (i.e., the first leaf node is a damaged leaf node), while the second leaf node is an island leaf node (e.g., due to damage to a top node of the second data path), since the damaged node cannot participate in a reconnection and only an upward connection can be performed based on the address information (i.e., offset) of the node in the related art, the island leaf node may be reconnected to an upper-level node of the first leaf node in a reconnection process, resulting in an erroneous reconnection.

In the related art, the reconnection only includes an upward connection. The upward connection refers to that a lower-level node calculates an upper-level node based on its own control group serial number and offset. Nodes in a unified control group all have the same control group serial number, and nodes corresponding to the same physical address space have the same offset. Therefore, if two nodes in the same control group correspond to the same physical address space, the control group serial numbers and offsets of the two nodes are exactly the same, and it can only be calculated that the upper-level node encompasses the same physical address space. In a case where the control group includes a plurality of data path trees, there are a plurality of intermediate nodes encompassing the same physical address space, resulting in an inability to determine which intermediate node the two nodes should be connected to respectively.

Further, after the first leaf node is restored, the first leaf node may be reconnected to an upper-level node of the second leaf node, thereby generating an erroneous reconnection again. Additionally, since the reconnection consumes substantial computational resources and takes a long time, four reconnections in the related art exhibit a low restoration efficiency.

To address this, the present disclosure provides a method for restoring data. According to the method of the present disclosure, a damaged leaf node is first restored, and then the leaf node is reconnected to an intermediate node, subsequently a damaged intermediate node is restored, and then the intermediate node is reconnected to a top node. In this way, data restoration can be completed by means of only two reconnections, which shows a high restoration efficiency. Furthermore, since a restoration operation is performed before a reconnection operation, non-damaged nodes will not be reconnected in advance relative to damaged nodes, so that the situation that leaf nodes in different data path trees are incorrectly reconnected can be avoided, thereby reducing the error rate.

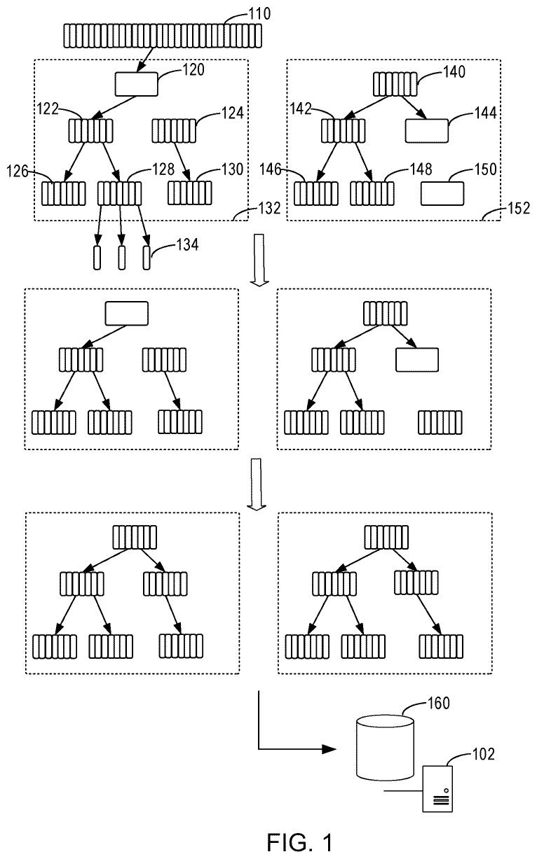

FIG. 1 is a schematic diagram of an example environment 100 in which embodiments according to the present disclosure can be implemented. As shown in FIG. 1, the environment 100 may include a data management unit 160 in a service unit 102. The method of the present embodiment is performed by the data management unit 160. Under normal circumstances, the data management unit 160 may map a logical address in a logical space 110 of the service unit 102 to a physical address such as a physical address 134 through a data path tree. In this way, the service unit 102 does not need to be aware of underlying storage methods, but only needs to invoke and process data based on the logical address. The data path tree such as a data path tree 132 is configured to store mapping between the logical address and the physical address. For example, a top node 120 of the data path tree 132 may indicate a physical address space of 1 TB in a memory. In some embodiments, the top node 120 may include 512 pointers, each pointer pointing to an intermediate node such as an intermediate node 122. Accordingly, each intermediate node may indicate a physical address space of 2 GB. Similarly, in some embodiments, the intermediate node 122 may include 512 pointers, each pointer capable of pointing to a leaf node such as a leaf node 128. Accordingly, each leaf node may indicate a physical address space of 4 MB. In some embodiments, a leaf node may include 512 pointers, each pointer pointing to a physical address of a data block with a size of 8 KB. In some embodiments, each node in the data path tree 132 is 4 KB in size.

During use of data, due to various reasons (such as memory failure), the node of the data path tree used to reflect the mapping between the logical address and the physical address may be damaged, resulting in an inability to determine which data block a logical address originally pointed to based on the data path tree. In some embodiments, if a value of a field for a magic number in a node is damaged, the node may be considered a damaged node. This is because the magic number is a specific value used to identify the node type or data form, and when the magic number is destroyed, it indicates that the data integrity of the node is affected. In some embodiments, if a value of a field for a checksum in a node is damaged, the node may be considered a damaged node. The checksum is a value obtained by calculating node data and used to verify the correctness of the data, and when the checksum is damaged, it indicates that an error may have occurred in the node data. In some embodiments, when address information of a node cannot be read, for example, when fault information is displayed, the node may be considered a damaged node. Since address information is critical information for determining node locations and connection relationships, failure to read the address information means that the node may have a severe fault.

In some embodiments, the data management unit 160 determines a damaged target node in a target snapshot group, wherein the target snapshot group includes a plurality of data path trees, each of the plurality of data path trees including a leaf node, an intermediate node, and a top node. FIG. 1 illustrates two data path trees 132 and 152 which constitute the target snapshot group. That is, under normal circumstances, the data path tree 132 and the data path tree 152 point to the same physical address. In the present embodiment, the data path tree 132 includes a top node 120, an intermediate node 122, an intermediate node 124, a leaf node 126, a leaf node 128, and a leaf node 130, and the data path tree 152 includes a top node 140, an intermediate node 142, an intermediate node 144, a leaf node 146, a leaf node 148, and a leaf node 150. The leaf node 128 includes a physical address pointing to a physical address 134, etc. In the present embodiment, it can be seen that the top node 120 of the data path tree 132 has been damaged, and the intermediate node 144 and the leaf node 150 of the data path tree 132 have been damaged.

In some embodiments, if the damaged target node includes a damaged leaf node, the data management unit 160 reconnects the leaf node to the intermediate node of the target snapshot group by restoring the damaged leaf node using a snapshot node of the damaged leaf node in the target snapshot group. The data management unit 160 may detect and find that the leaf node 150 is a damaged leaf node, and thus restore the leaf node 150 first. Since the data path trees in the target snapshot group have a corresponding relationship, for example, one of the data path trees indicates a data path of a certain data volume, while other data path trees indicate data paths of snapshots of the data volume. These snapshots can be snapshots at different times, and they record the states of the data volume at different time points. In some embodiments, when the leaf node 150 is being restored, restoration is implemented according to other data path trees in the target snapshot group. As shown in the middle portion of FIG. 1, the damaged leaf node 150 of the data path tree 152 is restored.

After the damaged leaf node is restored, the leaf node is reconnected to the intermediate node of the target snapshot group. Since the top node 120 is damaged, both the intermediate node 124 and the leaf node 130 are island nodes. In the related art, if the leaf nodes and the intermediate nodes are reconnected without restoring the damaged leaf node 150, the leaf node 130 may be incorrectly connected to the intermediate node 144. However, in the present embodiment, since the leaf node 150 has been restored, such situation can be avoided. When the leaf nodes are reconnected to intermediate nodes of the target snapshot group, even if an upward connection is performed only according to the control group serial numbers and node offsets, it may be observed that the node 130 and the node 150 may point to the same intermediate node. In some embodiments, restoration of the node 130 and the node 150 can be abandoned at this time, so that at least erroneous connections will not be mistaken for correct connections, thereby improving the accuracy of restoration.

In some embodiments, if the damaged target node includes a damaged intermediate node, the data management unit 160 reconnects the intermediate node to the top node of the target snapshot group by restoring the damaged intermediate node using a snapshot node of the damaged intermediate node in the target snapshot group. As shown in FIG. 1, the node 144 may be restored by restoring the damaged intermediate node using a snapshot node of the damaged intermediate node in the target snapshot group. In some embodiments, if the damaged target node includes a damaged top node 120, the damaged top node 120 is restored using a snapshot node of the damaged top node 120 in the target snapshot group. After the top node and the intermediate node are restored, the intermediate node may be reconnected to the top node of the target snapshot group, thereby restoring the correct data path tree 132 and data path tree 152. Restoration results are shown in the lower part of FIG. 1.

According to the method in the present embodiment, a data path restoration process is to repair a damaged leaf node, then reconnect the repaired leaf node to an intermediate node, restore a damaged intermediate node, and reconnect the restored intermediate node to a top node. This process only requires two reconnection operations to achieve data restoration, which is highly efficient. In addition, since the restoration operation takes precedence over the reconnection operation, undamaged nodes will not be reconnected before damaged nodes, so that the situation of incorrect reconnections of leaf nodes in different data path trees is effectively avoided, thereby reducing the error rate.

The service unit 102 may be a cloud server used for providing foundational cloud computing services such as cloud services, cloud databases, cloud computing, cloud functions, cloud storage, network services, cloud communications, middleware services, domain name services, security services, Content Delivery Networks (CDNs), and big data and artificial intelligence platforms. It should be noted that the method of the present disclosure may also be applied to scenarios of non-distributed systems, e.g., scenarios of centralized systems. In the present embodiment, although the service unit 102 is shown as a separate device, the service unit 102 may be embedded into a server cluster.

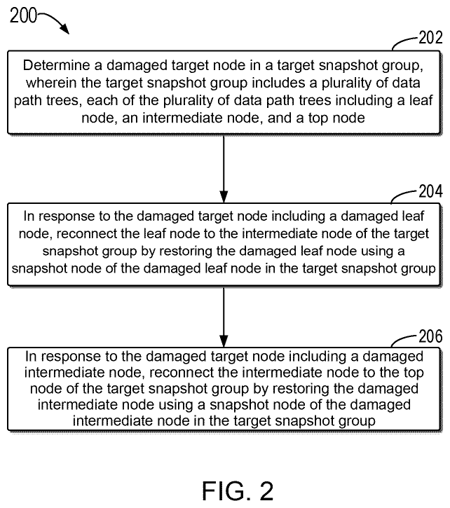

FIG. 2 illustrates a flow chart of a method for restoring data according to some embodiments of the present disclosure. As shown in FIG. 2, the flow chart 200 includes blocks 202 to 206. The method in the present embodiment may be implemented by the data management unit 160 shown in FIG. 1. At block 202, a damaged target node in a target snapshot group is determined, where the target snapshot group includes a plurality of data path trees, and each of the plurality of data path trees includes a leaf node, an intermediate node, and a top node. The target snapshot group is a collection including a plurality of data path trees. A certain association relationship exists among the data path trees, which is typically used to record mapping information of data in different states or at different time points, so as to perform operations such as data restoration when necessary. Data path trees in the same snapshot group have the same snapshot group serial number.

At block 204, in response to the damaged target node including a damaged leaf node, the leaf node is reconnected to the intermediate node of the target snapshot group by restoring the damaged leaf node using a snapshot node of the damaged leaf node in the target snapshot group. The damaged leaf node may be one type of damaged target node, which means that a node at a leaf level in a data path tree is damaged. The leaf node is used to point to a physical address of a specific data block, and the damaged leaf node results in an inability to correctly obtain the corresponding data block.

Reconnection refers to reconstructing connection relationships between nodes in a data path tree such that the data path tree can correctly map logical addresses and physical addresses to ensure normal access and use of data. A reconnection operation is performed according to the structure of the data path tree and logical relationships between nodes. When a leaf node is to be reconnected to an intermediate node, the correctness of the connection is determined according to pointer information of the leaf node and a corresponding address range of the intermediate node.

At block 206, in response to the damaged target node including a damaged intermediate node, the intermediate node is reconnected to the top node of the target snapshot group by restoring the damaged intermediate node using a snapshot node of the damaged intermediate node in the target snapshot group. The damaged intermediate node can also be one type of damaged target node, which means that a node at the middle level in the data path tree is damaged. An address range of the intermediate node encompasses that of the leaf node, and its damage will affect the structural integrity of the data path tree and the correct mapping of data.

According to the method of the present disclosure, a damaged leaf node is first restored, and then the leaf node is reconnected to an intermediate node, subsequently a damaged intermediate node is restored, and then the intermediate node is reconnected to a top node. In this way, data restoration can be completed by means of only two reconnections, which shows a high restoration efficiency. Furthermore, since a restoration operation is performed before a reconnection operation, non-damaged nodes will not be reconnected in advance relative to damaged nodes, so that the situation that leaf nodes in different data path trees are incorrectly reconnected can be avoided, thereby reducing the error rate.

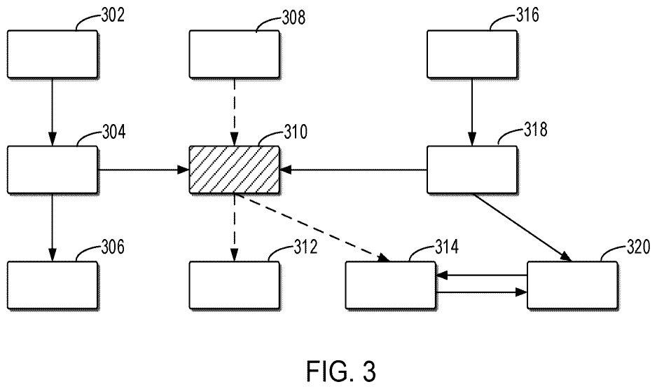

FIG. 3 illustrates a schematic diagram of a bidirectional reconnection according to an embodiment of the present disclosure. A target control group includes three data path trees. A first data path tree is composed of nodes 302, 304, and 306; a second data path tree is composed of nodes 308, 310, 312, and 314; and a third data path tree is composed of nodes 316, 318, and 320. As shown in FIG. 3, the intermediate node 310 is a damaged node. The data management unit 160, after detecting that the intermediate node 310 is a damaged node, may continue to detect associated nodes for the intermediate node 310. In some embodiments, the data management unit 160 may determine an upper-level node 308 of the intermediate node 310 as a faulty path node. In some embodiments, the data management unit 160 may determine a parent node 304 of the intermediate node 310 as a control node. In some embodiments, the data management unit 160 may determine a child node 318 of the intermediate node 310 as a control node. In some embodiments, the data management unit 160 may determine lower-level nodes 312 and 314 of the intermediate node 310 as island leaf nodes. Other nodes such as the top node 302, the top node 316, the leaf node 306, and the leaf node 320 are normal nodes, where the leaf node 314 is a parent node of the leaf node 320.

In the present embodiment, since the intermediate node 310 is damaged, the connection between the intermediate node 310 and the top node 308 disappears, the connection between the intermediate node 310 and the leaf node 312 disappears, and the connection between the intermediate node 310 and the leaf node 314 disappears, as indicated by dashed arrows.

In order to restore the connections to the intermediate node 310, in the present embodiment, the data management unit 160 may first detect the leaf nodes. Since there is no damaged node at the leaf level, in some embodiments, the leaf node may be directly reconnected to the intermediate node. In some embodiments, the data management unit 160 acquires a pointer from the intermediate node 310, where the pointer indicates a lower-level node corresponding to the intermediate node. Although the intermediate node 310 has been damaged, the pointer such as an address pointer pointing to a lower-level node, may still be retained. Although the pointer does not indicate the address range of the intermediate node 310, it can indicate the address of the lower-level node of the intermediate node 310.

For example, a metadata portion (e.g., an address range description field and a checksum field) of a node is damaged, but due to the locality of failure characteristics of storage media, the data in the pointer portion of the node is likely to remain intact. This is because the pointer is essentially a reference to a storage address, and in storage devices such as disks, the physical storage location of the pointer can be stored separately from other node data.

Therefore, the data management unit 160 can index a specific location of a lower-level node according to the node. In some embodiments, the data management unit 160 acquires a pointer from the intermediate node, where the pointer indicates a lower-level node corresponding to the intermediate node. In some embodiments, if the corresponding lower-level node is a restored damaged leaf node, the data management unit 160 reconnects the restored damaged leaf node to the intermediate node. This connection operation may be considered a downward connection, that is, connecting from an upper-level node to a lower-level node.

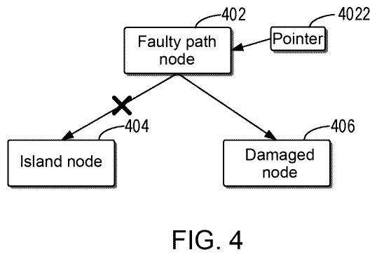

FIG. 4 illustrates an effect diagram of a downward connection according to the present disclosure. As shown in FIG. 4, a node 406 is a damaged node, so its upper-level node is a faulty path node 402. Additionally, an island node 404 exists in a target control group, which is at the same level as the damaged node 406.

Since the damaged node 406 cannot participate in an upward connection before being restored, if the damaged node 406 is not restored, the island node 404 will be reconnected before the damaged node 406. Assuming that the island node 404 and the damaged node 406 have the same control group serial number and offset, it can be calculated in the upward connection that the island node 404 can be connected to the faulty path node 402, thereby causing an erroneous connection. Therefore, the damaged node 406 needs to be restored first. However, it is still impossible to further distinguish which of the island node 404 and the damaged node 406 should be connected to the faulty path node 402.

In the present embodiment, the downward connection is initiated before the upward connection. That is, configuration information of the faulty path node 402 is detected to obtain a pointer 4022. The pointer 4022 may point to an address of the damaged node 406. In this way, the damaged node 406 and the faulty path node 402 can be directly reconnected based on the pointer 4022, thereby establishing a correct connection relationship. As for the island node 404, it may be reconnected to a control node corresponding to the faulty path node 402, for example.

In order to further ensure the correctness of the reconnection, it is also possible to verify whether an upper-level node of a lower-level node is the intermediate node 310 according to the control group serial number and offset of the lower-level node. In some embodiments, an inferred node is determined based on an offset address of the restored damaged leaf node. For example, an upper-level node may be calculated based on the control group serial numbers and offsets of the leaf node 312 and the leaf node 314. This connection operation can be considered the upward connection. In some embodiments, if the inferred node is an intermediate node, it is confirmed that there is a connection between the damaged leaf node and the intermediate node. In the present embodiment, the accuracy of reconnection can be improved through a bidirectional reconnection operation, thereby improving the accuracy of data restoration.

In some embodiments, if the damaged target node includes a damaged leaf node, a parent node and a child node of the damaged leaf node are determined. In a storage structure of a data path tree, each node stores association information pointing to the parent node and child node (if any). The data management unit 160, when determining a parent node of a damaged leaf node, will first check parent node association information carried by the damaged leaf node itself. If this information is valid, a storage location of the parent node can be directly obtained. In some embodiments, the parent node may be a snapshot node that precedes or is equal to the current node, and the child node may be a snapshot node that follows or is equal to the current node.

In some embodiments, if the parent node and the child node are identical, the damaged leaf node is restored according to the parent node or the child node to obtain a restored damaged leaf node. The parent node and the child node being identical means that data of a data volume has not changed between the previous snapshot and the next snapshot, then the present node should also remain unchanged, and therefore, the damaged leaf node can be restored based on either the parent node or the child node.

In some embodiments, if the parent node and the child node are not identical, the damaged leaf node is restored according to the child node to obtain a restored damaged leaf node. If the parent node and the child node are not identical, the child node can be used as the basis because the child node represents the latest data, which can provide restoration availability.

In some embodiments, the leaf node is reconnected to the intermediate node of the target snapshot group based on the restored damaged leaf node. This method of restoring leaf nodes is also applicable to intermediate nodes and top nodes. For example, the parent node and the child node of the intermediate node are determined, if the parent node and the child node are identical, the intermediate node is restored according to the parent node or the child node, and based on the restored damaged intermediate node, the intermediate node is reconnected to the top node of the target snapshot group.

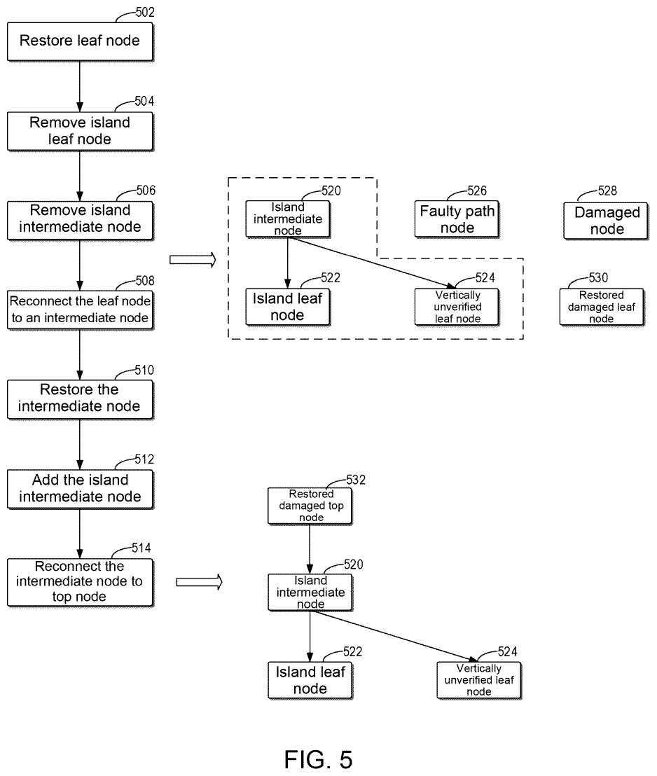

FIG. 5 illustrates a schematic diagram of processing island nodes according to an embodiment of the present disclosure. At 502, a leaf node in a target control group is restored. In some embodiments, the data management unit 160 may perform a deep scan on all damaged leaf nodes in the target snapshot group, and locate the leaf nodes that need to be restored by comparing the values of fields for checksum, magic number, etc. of the nodes with those of other normal leaf nodes in the target snapshot group. When a damaged leaf node is found, a cross-tree collaborative restoration mechanism may be activated to traverse leaf nodes at corresponding locations in other data path trees within the target snapshot group and collect configuration information of the nodes (e.g., pointer pointing, data block address). The damaged node is restored based on data from control nodes.

At 504, before the leaf node and the intermediate node of the target snapshot group are reconnected, an island leaf node and a vertically unverified leaf node are removed from the leaf node. The island leaf node refers to a node that is at the leaf level, has lost an indirect connection to a top node, but may still have a connection to an intermediate node. The vertically unverified leaf node refers to a node that is at the leaf level, has lost an indirect connection to a top node, but has connections to other nodes at the leaf level, and may also have a connection to an intermediate node. Both types of nodes require reconstructing indirect connections to the top node. For example, if two lower-level nodes of an intermediate node 520 are a leaf node 522 and a vertically unverified leaf node 524, respectively, once an upper-level node (i.e., a certain top node) of the intermediate node 520 is damaged, the intermediate node 520 is called an island intermediate node 520, and the nodes 522 and 524 are called island leaf node 522 and vertically unverified leaf node 524, respectively. However, the island leaf node 522 and the vertically unverified leaf node 524 are still connected to the intermediate node 520.

In this step, since the island leaf node 522 and the vertically unverified leaf node 524 can be determined to be connected to the island intermediate node 520, there is no need to reconnect the island leaf node 522 and the vertically unverified leaf node 524. If the two nodes are reconnected and the reconnection is performed based only on their control group serial numbers and offsets, an erroneous connection to other nodes may be caused. Therefore, in this step, only a faulty path node 526 and a damaged node 528 are reconnected as intermediate nodes, and only a restored damaged leaf node 530 is reconnected as a leaf node. In the present embodiment, removing the island leaf node 522 and the vertically unverified leaf node 524 in advance can improve both the restoration efficiency and the restoration accuracy.

At 506, before the leaf node is reconnected to the intermediate node of the target snapshot group, the island intermediate node is removed from the intermediate node. That is, the island intermediate node does not participate in the reconnection at 508. Since the island leaf node 522 and the vertically unverified leaf node 524 have been removed, there is no need for the island intermediate node 520 to participate in the reconnection, so it can be removed in this reconnection and directly participate in the reconnection of the intermediate node to the top node.

At 508, the leaf node is reconnected to the intermediate node. The reconnection may be the bidirectional reconnection as shown in FIG. 3. On the one hand, a corresponding leaf node is determined according to a pointer of the intermediate node, and on the other hand, a corresponding intermediate node is calculated according to the control group serial number and offset of the leaf node for verification. At 510, the intermediate node is restored. In some embodiments, the top node may also be restored. The restoration process may utilize information from control nodes. Not every node necessarily has both a parent node and a child node. If only one (e.g., parent node) exists, the intermediate node or top node can be directly restored according to the parent node.

At 512, after reconnecting the leaf node to the intermediate node of the target snapshot group and prior to reconnecting the intermediate node to the top node of the target snapshot group, adding the island intermediate node to the intermediate node. Regardless of whether the top node is restored, the damaged node can be reconnected as an upper-level node. In the present embodiment, in order to completely restore the target control group, the island intermediate node needs to be reconnected to the top node. Therefore, it is necessary to add the island intermediate node to the intermediate node. At 514, the intermediate node is reconnected to the top node. In this process, a corresponding intermediate node (e.g., the island intermediate node 520) may be detected according to a pointer of a top node 532. If the pointer of the top node 532 is also damaged, only an upward connection may be performed, i.e., calculating which top node the island intermediate node 520 should be connected to according to the control group serial number and offset of the island intermediate node 520.

Since the island leaf node 522 and the vertically unverified leaf node 524 can be determined to be connected to the island intermediate node 520, the island leaf node 522 and the vertically unverified leaf node 524 have been automatically indirectly reconnected to the top node 532 at this time and become normal nodes. Therefore, in the present embodiment, the efficiency and accuracy of restoring data path trees can be significantly improved.

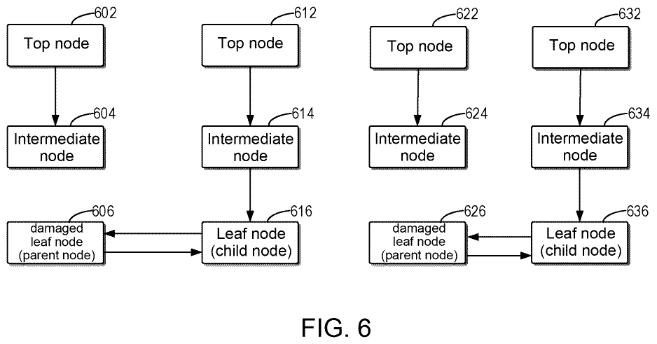

FIG. 6 illustrates a schematic diagram of restoring a plurality of damaged leaf nodes according to an embodiment of the present disclosure. In the present embodiment, there are two damaged leaf nodes, i.e., a first damaged leaf node 606 and a second damaged leaf node 626. A target control group includes four data path trees, among which a top node 602, an intermediate node 604, and a damaged leaf node 606 belong to a first data path tree, a top node 612, an intermediate node 614, and a leaf node 616 belong to a second data path tree, a top node 622, an intermediate node 624, and a damaged leaf node 626 belong to a third data path tree, and a top node 632, an intermediate node 634, and a leaf node 636 belong to a fourth data path tree. The damaged leaf node 606 is a parent node of the leaf node 616, and the damaged leaf node 626 is a parent node of the leaf node 636. The leaf node 616 is a child node of the damaged leaf node 606, and the leaf node 636 is a child node of the damaged leaf node 626.

In the present embodiment, the data management unit may first restore the damaged leaf node 606 and the damaged leaf node 626. For example, the damaged leaf node 606 can be restored by copying data from the leaf node 616, and the damaged leaf node 626 can be restored by copying data from the leaf node 636.

After the damaged leaf node 606 and the damaged leaf node 626 are restored, the damaged leaf node 606 and the damaged leaf node 626 are used as leaf nodes and the intermediate node 604 and the intermediate node 634 are used as intermediate nodes to perform a reconnection operation. If the reconnection is performed based only on the control group serial numbers and offsets, the nodes may be erroneously connected to other nodes. For example, the damaged leaf node 606 may be reconnected to the intermediate node 624, and the damaged leaf node 626 may be reconnected to the intermediate node 604. Therefore, in this step, configuration information of the intermediate node 604 and the intermediate node 624 is first detected. If pointers thereof are not damaged, then according to the pointers, the address of the leaf node to which the intermediate node 604 is originally connected, i.e., the address of the damaged leaf node 606, as well as the address of the leaf node to which the intermediate node 624 is originally connected, i.e., the address of the lea damaged node 626, can be determined. After the reconnection is performed according to the pointers, verification is then performed according to the control group serial numbers and offsets of the damaged leaf node 606 and the damaged leaf node 626. If the verification succeeds, the reconnection is confirmed as accurate. Since the intermediate nodes and the top nodes in the present embodiment are fully intact, there is no need to perform operations of restoring the intermediate nodes and reconnecting the intermediate nodes to the top nodes.

TABLE 1
shows the restoration status of data
path trees for a 10 GB data volume:

| | Number of | Amount of | Data Loss |
|---|---|---|---|
| Strategy | Damaged Nodes | Erroneous Data | Rate |
| Related Art | 16 | 64 MB | 0.625% |
| Embodiment of the | 16 | 16 MB | 0.156% |
| Present Disclosure | | | |

When 16 nodes are manually damaged for a 10 GB data volume, the restoration in the related art will generate 64 MB of erroneous data with a data loss rate of 0.625%, while the embodiment of the present disclosure generates only 16 MB of erroneous data with a data loss rate of only 0.156%. It can be seen that the technical method disclosed in the present disclosure can greatly improve the accuracy of data restoration.

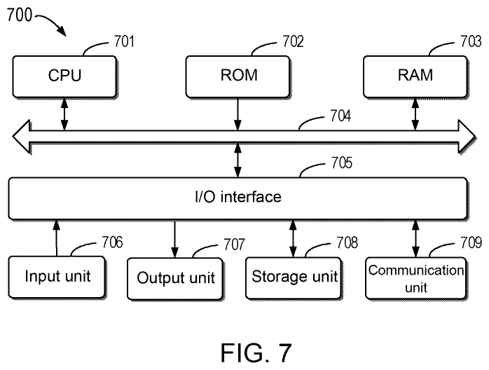

FIG. 7 illustrates a schematic block diagram of an example device 700 that can be used to implement the embodiments of the present disclosure. As shown in the figure, the device 700 includes a computing unit 701 that can perform various appropriate actions and processing according to computer program instructions stored in a read-only memory (ROM) 702 or computer program instructions loaded from a storage unit 708 to a random access memory (RAM) 703. Various programs and data required for the operation of the device 700 may also be stored in the RAM 703. The computing unit 701, the ROM 702, and the RAM 703 are connected to each other via a bus 705. An input/output (I/O) interface 705 is also connected to the bus 705.

A plurality of components in the device 700 are connected to the I/O interface 705, including: an input unit 706 such as a keyboard and a mouse; an output unit 707 such as various types of displays and speakers; the storage unit 708 such as a magnetic disk and an optical disc; and a communication unit 709 such as a network card, a modem, and a wireless communication transceiver. The communication unit 709 allows the device 700 to exchange information/data with other devices via a computer network such as the Internet, and/or various telecommunication networks.

The computing unit 701 may be various general-purpose and/or special-purpose processing components with processing and computing powers. Some examples of the computing unit 701 include, but are not limited to, central processing units (CPUs), graphics processing units (GPUs), various specialized artificial intelligence (AI) computing chips, various computing units for running machine learning model algorithms, digital signal processors (DSPs), and any appropriate processors, controllers, microcontrollers, etc. The computing unit 701 performs various methods and processes described above, such as the method 200. For example, in some embodiments, the method 200 may be implemented as a computer software program that is tangibly included in a machine readable medium, such as the storage unit 708. In some embodiments, part or all of the computer program may be loaded and/or installed onto the device 700 via the ROM 702 and/or the communication unit 709. When the computer program is loaded to the RAM 703 and executed by the computing unit 701, one or more steps of the method 200 described above may be performed. Alternatively, in other embodiments, the computing unit 701 may be configured to implement the method 200 in any other suitable manners (such as by means of firmware).

The functions described hereinabove can be performed at least in part by one or more hardware logic components. For example, non-restrictively, demonstration types of hardware logic components that can be used include Field Programmable Gate Arrays (FPGAs), Application Specific Integrated Circuits (ASICs), Application Specific Standard Products (ASSPs), Systems On Chip (SOC), Load Programmable Logic Devices (CPLDs), etc.

Program codes for implementing the method of the present disclosure may be written by using one programming language or any combination of multiple programming languages. The program codes may be provided to a processor or controller of a general purpose computer, a special purpose computer, or another programmable data processing apparatus, such that the program codes, when executed by the processor or controller, cause the functions/operations specified in the flow charts and/or block diagrams to be implemented. The program codes may be executed completely on a machine, executed partially on a machine, executed partially on a machine and partially on a remote machine as a stand-alone software package, or executed completely on a remote machine or server.

In the context of the present disclosure, a machine-readable medium may be a tangible medium that may include or store a program for use by an instruction execution system, apparatus, or device or in connection with the instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include one or more wire-based electrical connections, a portable computer diskette, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination thereof. Additionally, although operations are depicted in a particular order, it should be understood that such operations are required to be performed in the particular order shown or in a sequential order, or that all illustrated operations should be performed to achieve desirable results. In certain environments, multitasking and parallel processing may be advantageous. Likewise, although the above discussion contains several specific implementation details, these should not be construed as limitations to the scope of the present disclosure. Certain features that are described in the context of separate embodiments may also be implemented in combination in a single implementation. In contrast, various features that are described in the context of a single implementation may also be implemented in multiple implementations separately or in any suitable sub-combination.

The computer-readable program instructions described herein may be downloaded from a computer-readable storage medium to various computing/processing devices, or downloaded to an external computer or external storage device via a network, such as the Internet, a local area network, a wide area network, and/or a wireless network. The network may include copper transmission cables, optical fiber transmission, wireless transmission, routers, firewalls, switches, gateway computers, and/or edge servers. A network adapter card or network interface in each computing/processing device receives computer-readable program instructions from a network and forwards the computer-readable program instructions for storage in a computer-readable storage medium in each computing/processing device.

The computer program instructions for performing the operations of the present disclosure may be assembly instructions, instruction set architecture (ISA) instructions, machine instructions, machine-related instructions, microcode, firmware instructions, status setting data, or source code or object code written in any combination of one or more programming languages, the programming languages including object-oriented programming languages, such as Smalltalk and C++, as well as conventional procedural programming languages, such as the C language or similar programming languages. The computer-readable program instructions may be executed entirely on a user's computer, partly on a user's computer, as a stand-alone software package, partly on a user's computer and partly on a remote computer, or entirely on a remote computer or a server. In a case where a remote computer is involved, the remote computer can be connected to a user computer through any kind of networks, including a local area network (LAN) or a wide area network (WAN), or can be connected to an external computer (for example, connected through the Internet using an Internet service provider). In some embodiments, an electronic circuit, such as a programmable logic circuit, a field programmable gate array (FPGA), or a programmable logic array (PLA), is customized by utilizing status information of the computer-readable program instructions. The electronic circuit may execute the computer-readable program instructions to implement various aspects of the present disclosure.

Various aspects of the present disclosure are described herein with reference to flow charts and/or block diagrams of the method, the apparatus (system), and the computer program product according to the embodiments of the present disclosure. It should be understood that each block of the flow charts and/or the block diagrams and combinations of blocks in the flow charts and/or the block diagrams may be implemented by the computer-readable program instructions.

These computer-readable program instructions may be provided to a processing unit of a general-purpose computer, a special-purpose computer, or other programmable data processing apparatuses to produce a machine, such that these instructions, when executed by the processing unit of the computer or other programmable data processing apparatuses, produce means (e.g., specialized circuitry) for implementing the functions/actions specified in one or more blocks in the flow charts and/or block diagrams. These computer-readable program instructions may also be stored in a computer-readable storage medium, and these instructions cause a computer, a programmable data processing apparatus, and/or other devices to operate in a specific manner; and thus the computer-readable medium having instructions stored thereon includes an article of manufacture that includes instructions that implement various aspects of the functions/actions specified in one or more blocks in the flow charts and/or block diagrams.

The computer-readable program instructions may also be loaded onto a computer, other programmable data processing apparatuses, or other devices, such that a series of operations or steps are performed on the computer, other programmable data processing apparatuses, or other devices to produce a computer-implemented process, such that the instructions executed on the computer, other programmable data processing apparatuses, or other devices implement the functions/actions specified in one or more blocks in the flow charts and/or block diagrams.

The flow charts and block diagrams in the drawings illustrate the architectures, functions, and operations of possible implementations of the systems, methods, and computer program products according to a plurality of embodiments of the present disclosure. In this regard, each block in the flow charts or block diagrams may represent a module, a program segment, or part of an instruction, the module, program segment, or part of an instruction including one or more executable instructions for implementing specified logical functions. In some alternative implementations, functions marked in the blocks may also occur in an order different from that marked in the accompanying drawings. For example, two successive blocks may actually be executed in parallel substantially, and sometimes they may also be executed in a reverse order, which depends on involved functions. It should be further noted that each block in the block diagrams and/or flow charts as well as a combination of blocks in the block diagrams and/or flow charts may be implemented using a dedicated hardware-based system that executes specified functions or actions, or using a combination of special hardware and computer instructions.

The embodiments of the present disclosure have been described above. The above description is illustrative rather than exhaustive, and is not limited to the disclosed various embodiments. Numerous modifications and alterations are apparent to persons of ordinary skill in the art without departing from the scope and spirit of the illustrated embodiments. The selection of terms used herein is intended to best explain the principles and practical applications of the various embodiments or the improvements to technologies on the market, or to enable other persons of ordinary skill in the art to understand the embodiments disclosed here.

1. A method for restoring data, comprising:
determining a damaged target node in a target snapshot group, wherein the target snapshot group includes a plurality of data path trees, each of the plurality of data path trees including a leaf node, an intermediate node, and a top node;
in response to the damaged target node including a damaged leaf node, reconnecting the leaf node to the intermediate node of the target snapshot group by restoring the damaged leaf node using a snapshot node of the damaged leaf node in the target snapshot group; and
in response to the damaged target node including a damaged intermediate node, reconnecting the intermediate node to the top node of the target snapshot group by restoring the damaged intermediate node using a snapshot node of the damaged intermediate node in the target snapshot group.

2. The method according to claim 1, wherein the in response to the damaged target node including a damaged leaf node, reconnecting the leaf node to the intermediate node of the target snapshot group by restoring the damaged leaf node using a snapshot node of the damaged leaf node in the target snapshot group comprises:
in response to the damaged target node including the damaged leaf node, determining a parent node and a child node of the damaged leaf node;
in response to the parent node and the child node being identical, restoring the damaged leaf node according to the parent node or the child node to obtain a restored damaged leaf node; and
based on the restored damaged leaf node, reconnecting the leaf node to the intermediate node of the target snapshot group.

3. The method according to claim 2, further comprising:
in response to the parent node and the child node being not identical, restoring the damaged leaf node according to the child node to obtain a restored damaged leaf node.

4. The method according to claim 2, wherein the based on the restored damaged leaf node, reconnecting the leaf node to the intermediate node of the target snapshot group comprises:
acquiring a pointer from the intermediate node, wherein the pointer indicates a lower-level node corresponding to the intermediate node; and
in response to the corresponding lower-level node being the restored damaged leaf node, reconnecting the restored damaged leaf node to the intermediate node.

5. The method according to claim 4, wherein the in response to the corresponding lower-level node being the restored damaged leaf node, reconnecting the restored damaged leaf node to the intermediate node comprises:
determining an inferred node according to an offset address of the restored damaged leaf node; and
in response to the inferred node being the intermediate node, confirming that there is a connection between the damaged leaf node and the intermediate node.

6. The method according to claim 1, wherein the intermediate node comprises an island intermediate node, and the method further comprises:
determining an island leaf node and a vertically unverified leaf node of the island intermediate node according to a pointer of the island intermediate node;
prior to reconnecting the leaf node to the intermediate node of the target snapshot group, removing the island leaf node and the vertically unverified leaf node from the leaf node; and
prior to reconnecting the leaf node to the intermediate node of the target snapshot group, removing the island intermediate node from the intermediate node.

7. The method according to claim 6, further comprising:
after reconnecting the leaf node to the intermediate node of the target snapshot group and prior to reconnecting the intermediate node to the top node of the target snapshot group, adding the island intermediate node to the intermediate node.

8. The method according to claim 6, wherein there is a connection between the island leaf node and the island intermediate node, and there is a connection between the vertically unverified leaf node and the island intermediate node.

9. The method according to claim 1, wherein the damaged leaf node comprises a first damaged leaf node and a second damaged leaf node, and the reconnecting the leaf node to the intermediate node of the target snapshot group by restoring the damaged leaf node using a snapshot node of the damaged leaf node in the target snapshot group comprises:
selecting a first intermediate node and a second intermediate node from the intermediate node, wherein a pointer of the first intermediate node points to the first damaged leaf node, and a pointer of the second intermediate node points to the second damaged leaf node;
reconnecting the first damaged leaf node to the first intermediate node; and
reconnecting the second damaged leaf node to the second intermediate node.

10. The method according to claim 1, further comprising:
in response to the damaged target node including a damaged top node, restoring the damaged top node using a snapshot node of the damaged top node in the target snapshot group.

11. An electronic device, comprising:
at least one processor; and
coupled to the at least one processor and having instructions stored therein, wherein the instructions, when executed by the at least one processor, cause the electronic device to perform the following:
determining a damaged target node in a target snapshot group, wherein the target snapshot group includes a plurality of data path trees, each of the plurality of data path trees including a leaf node, an intermediate node, and a top node;
in response to the damaged target node including a damaged leaf node, reconnecting the leaf node to the intermediate node of the target snapshot group by restoring the damaged leaf node using a snapshot node of the damaged leaf node in the target snapshot group; and
in response to the damaged target node including a damaged intermediate node, reconnect the intermediate node to the top node of the target snapshot group by restoring the damaged intermediate node using a snapshot node of the damaged intermediate node in the target snapshot group.

12. The electronic device according to claim 11, wherein the instruction for, in response to the damaged target node including a damaged leaf node, reconnecting the leaf node to the intermediate node of the target snapshot group by restoring the damaged leaf node using a snapshot node of the damaged leaf node in the target snapshot group comprises instructions for:
in response to the damaged target node including the damaged leaf node, determining a parent node and a child node of the damaged leaf node;
in response to the parent node and the child node being identical, restoring the damaged leaf node according to the parent node or the child node to obtain a restored damaged leaf node; and
based on the restored damaged leaf node, reconnecting the leaf node to the intermediate node of the target snapshot group.

13. The electronic device according to claim 12, wherein the instructions, when executed by the at least one processor, further cause the electronic device to perform the following:
in response to the parent node and the child node being not identical, restoring the damaged leaf node according to the child node to obtain a restored damaged leaf node.

14. The electronic device according to claim 12, wherein the instruction for, based on the restored damaged leaf node, reconnecting the leaf node to the intermediate node of the target snapshot group comprises instructions for:
acquiring a pointer from the intermediate node, wherein the pointer indicates a lower-level node corresponding to the intermediate node; and
in response to the corresponding lower-level node being the restored damaged leaf node, reconnecting the restored damaged leaf node to the intermediate node.

15. The electronic device according to claim 14, wherein the instruction for, in response to the corresponding lower-level node being the restored damaged leaf node, reconnecting the restored damaged leaf node to the intermediate node comprises instructions for:
determining an inferred node according to an offset address of the restored damaged leaf node; and
in response to the inferred node being the intermediate node, confirming that there is a connection between the damaged leaf node and the intermediate node.

16. The electronic device according to claim 11, wherein the intermediate node comprises an island intermediate node, and the instructions, when executed by the at least one processor, further cause the electronic device to perform the following:
determining an island leaf node and a vertically unverified leaf node of the island intermediate node according to a pointer of the island intermediate node;
prior to reconnecting the leaf node to the intermediate node of the target snapshot group, removing the island leaf node and the vertically unverified leaf node from the leaf node; and
prior to reconnecting the leaf node to the intermediate node of the target snapshot group, removing the island intermediate node from the intermediate node.

17. The electronic device according to claim 16, wherein the instructions, when executed by the at least one processor, further cause the electronic device to perform the following:
after reconnecting the leaf node to the intermediate node of the target snapshot group and prior to reconnecting the intermediate node to the top node of the target snapshot group, adding the island intermediate node to the intermediate node.

18. The electronic device according to claim 16, wherein there is a connection between the island leaf node and the island intermediate node, and there is a connection between the vertically unverified leaf node and the island intermediate node.

19. The electronic device according to claim 11, wherein the damaged leaf node comprises a first damaged leaf node and a second damaged leaf node, and the instruction for reconnecting the leaf node to the intermediate node of the target snapshot group by restoring the damaged leaf node using a snapshot node of the damaged leaf node in the target snapshot group comprises instructions for:
selecting a first intermediate node and a second intermediate node from the intermediate node, wherein a pointer of the first intermediate node points to the first damaged leaf node, and a pointer of the second intermediate node points to the second damaged leaf node;
reconnecting the first damaged leaf node to the first intermediate node; and
reconnecting the second damaged leaf node to the second intermediate node.

20. A computer program product having a non-transitory computer readable medium which stores a set of instructions to restore data; the set of instructions, when carried out by computerized circuitry, causing the computerized circuitry to perform a method of:
determining a damaged target node in a target snapshot group, wherein the target snapshot group includes a plurality of data path trees, each of the plurality of data path trees including a leaf node, an intermediate node, and a top node;
in response to the damaged target node including a damaged leaf node, reconnecting the leaf node to the intermediate node of the target snapshot group by restoring the damaged leaf node using a snapshot node of the damaged leaf node in the target snapshot group; and
in response to the damaged target node including a damaged intermediate node, reconnecting the intermediate node to the top node of the target snapshot group by restoring the damaged intermediate node using a snapshot node of the damaged intermediate node in the target snapshot group.
